(19) United States
(12) Patent Application Publication
(10) Pub. No.: US 2024/0147595 A1
(43) Pub. Date: May 2, 2024

(54) POE POWERED MODULAR STREET LIGHT ASSEMBLY

(71) Applicant: Jesus Rodriguez, Brick Township, NJ (US)

(72) Inventor: Jesus Rodriguez, Brick Township, NJ (US)

(21) Appl. No.: 18/233,383

(22) Filed: Aug. 14, 2023

Related U.S. Application Data
(60) Provisional application No. 63/421,557, filed on Nov. 1, 2022.

(51) Int. Cl. H05B 47/105; F21S 8/08; H04L 67/125; H05B 47/19

(52) U.S. Cl. CPC H05B 47/105; F21S 8/086; H04L 67/125; H05B 47/19; F21W 2131/103

(57) ABSTRACT

The present invention is a modularized private mesh networked streetlight pole, comprising: a base; a main body attached to the base; a lamp mounted on the main body and having an electrical connection; a first set of sensors affixed to an exterior of the main body and having electrical connections; and a second set of sensors affixed to an interior of the main body having electrical connections.

### CROSS-REFERENCE TO RELATED APPLICATIONS

This application is a continuation-in-part (and claims the benefit of priority under 35 USC 120) of U.S. application No. 63/421,557 filed Nov. 1, 2022. The disclosure of the prior applications is considered part of (and is incorporated by reference in) the disclosure of this application.

### BACKGROUND OF THE INVENTION

The present invention relates to streetlight or street pole, and more particularly to a streetlight or street pole with Power over Ethernet (POE).

Outdoor lights using incandescent light bulbs have commonly been used to illuminate streets, parking lots, sidewalks, parks, and other public areas. Over the years, conventional streetlights have been modified to provide functions other than illumination. However, the majority of streetlights and parking lot lights still use incandescent light bulbs which result in unwanted glare, light trespass, energy waste, and sky glow.

In densely populated urban areas, there has long existed a problem that base stations do not have sufficient channel capacities and usually are not able to meet growing demands of communication service in those areas. An effective solution to this problem is to build new mobile communication base stations. However, urban public land available for communication operators to build base stations is becoming limited due to rapid developments in the city, and more and more residents protest against building the base stations due to health concerns, thereby leading to great difficulty in finding a place where the base stations can be built.

Moreover, traditional municipal streetlights generally are only used for road lighting and thus are restricted in function. Current municipal streetlights nevertheless are usually provided with infrastructure including electricity introduction, lightning protection grounding and towers (which have a certain height for wireless signal emission), and relatively are widely distributed. Such infrastructure happens to be necessary for construction of communication base stations. Therefore, how to effectively utilize current city infrastructure to solve the problem of existing base stations is thus an important task in the art.

### SUMMARY

In a first embodiment, the present invention is a modularized private mesh networked streetlight pole, comprising: a base; a main body attached to the base; a lamp mounted on the main body and having an electrical connection; a first set of sensors affixed to an exterior of the main body and having electrical connections; and a second set of sensors affixed to an interior of the main body having electrical connections.

In a second embodiment, the present invention is a modularized private mesh networked streetlight pole, comprising: a frame; a switch integrated into the frame, wherein the switch is connected to a network; a set of devices and sensors attached to the frame;

In a first embodiment, the present invention is a modularized private mesh networked, comprising: a group of smart poles connected to a network; a switch connected to the network in communication with the group of smart poles; and a power source connected to the switch, wherein the switch controls the power to the group of smart poles.

### BRIEF DESCRIPTION OF THE DRAWINGS

FIG. 1 depicts an image of a street light pole, in accordance with one embodiment of the present invention.

FIG. 2 depicts an image of a street light fixture, in accordance with one embodiment of the present invention.

FIG. 3 depicts a block diagram of a PoE environment, in accordance with one embodiment of the present invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

The present invention provides a fully Power over Ethernet (PoE) powered smart pole that can power streetlights, wireless access points, microwave antennas, IOT sensors, surveillance cameras, emergency call station, chargers, gunshot detection sensors, and various other sensors and systems that are able to be integrated into the smart pole and can transfer data and power through the PoE system. With the modular design, the smart pole is able to be retrofitted with a variety of light sources, sensors, and devices based on the needs of the area or the specific location. This provides tremendous benefits in that a single light pole can be used for a variety of purposes while also needing minimal work to modify the devices or sensors on the smart pole given that all the devices or sensors are connected via the PoE system. This reduces material costs, electricity requires to operate the smart post devices and sensors, and a modular smart pole design in which devices or sensors can be removed, replaced, or adjusted with ease. As well as the ability to control all the devices and sensors remotely with the PoE system design.

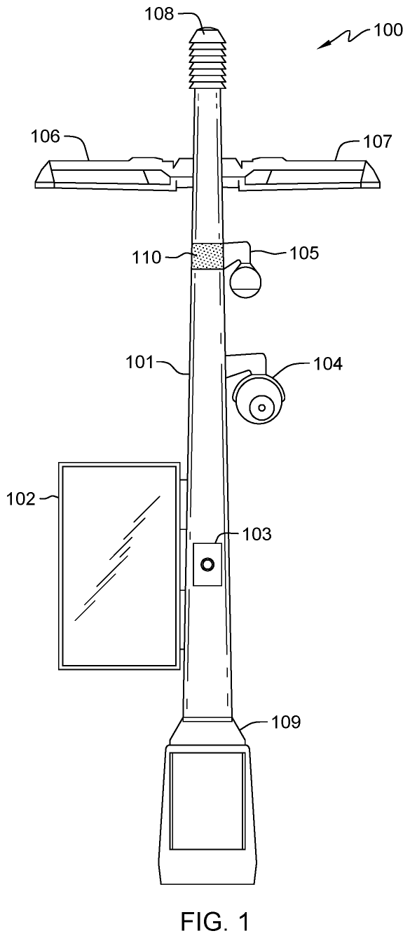

As shown in FIG. 1, a smart pole 100 is shown in accordance with one embodiment. The smart pole 100 has a variety of mounting locations and types to allow for the connection of various devices and sensors both mechanically to the smart pole 100 as well as electronically to the PoE system. In some embodiments, devices or sensors may be contained within the smart pole 100 based on the type of data collected or transmitted from the device or sensor. In the depicted embodiment, smart pole 100 has an LED display 102, an emergency call box 103, a camera 104, an environmental sensor 105, streetlights 106, and 107, and a point to multi point communication module 108. In some embodiments, module 108 is a point to point communication module. In additional embodiments, additional devices or sensors may be incorporated into the smart pole 100 based on both attachment means, the available attachment points, and the capacity of the smart pole 100. Base 109 of the smart pole provides for a housing for the electrical components needed within the smart pole 100. In the depicted embodiment, the environmental sensor 105 is connected externally to the hollow standard body 101, via a universal mount 110.

The smart pole 100 has a hollow standard body 101 having a lower end and an upper end. The lower end is connected to base 109 which is secured to the ground or surface. At the upper end are various mounting locations for devices and sensors. The height of the hollow standard body 101 is based on the location and desired number of devices and sensors to be attached. The base is sized to properly support the hollow standard body and provide a housing for the switch and other electrical components which are stored within smart pole 100.

The sensors and components can be, but not limited to, noise sensors, environmental monitoring sensors, air pollution sensors, temperature and humidity sensors, brightness sensors, security monitoring systems, vehicle and people monitoring systems, population monitoring systems, manhole monitoring systems, emergency call broadcasting systems, and the like

The devices and sensors which are attached to the smart pole 100 are done so through various mechanical connection means. In some embodiments, each smart pole 100 may have a set of predetermined mounting locations on various sides of the smart pole 100 that any device or sensor can attach to. In some embodiments, each attachment point may be designed for specific devices or sensors. For example, the Point to Multi Point communication device or alternate wireless mesh private network antenna is located at the top of the smart pole 100 with the lights positioned below at the second highest point, and the various sensors or devices positioned below based on the ideal mounting location for the device or sensor. The smart pole 100 has a structural design similar to that of the present-day streetlights.

The base 109 and hollow standard body 101 can have various designs both based on location and requirements. Integrated within the structure of the light pole is the PoE system including all necessary sensors. Through the PoE system, all the components and sensors on the smart pole 100 are able to be powered and operated via the PoE system. This allows for a modular design, and a smart pole 100 that requires less power, less wiring, and more features. The shaft may come with predetermined mounting points for each sensor and component. The PoE system is able to easily be connected both mechanically and electrically to each of the sensors and components via the internal wiring system and design. In some embodiments, various mounting locations are predetermined and designed for specific types of sensors or devices based on the height of the mounting locations. In some embodiments, external mounting systems such as clamps or brackets are used to secure the sensors or devices to the exterior of the smart pole 100.

The system works on a managed PoE switch which is manufactured to meet the needs of the smart pole 100 devices and sensors. The PoE smart pole 100 may require only 48 VAC to power the devices and sensors pictured in FIG. 1 through the PoE switch. In additional embodiments, where the smart pole 100 is a retrofit of an older street light design, the PoE switch is able to convert a streetlight of between 277 VAC or 408 VAC to around 48 VAC. The PoE switch is able to reduce the average 10-20 amps per streetlight, to under 2-5 amps for a fully loaded smart pole. 100

In some embodiments, through the use of a splitter, the number of wires can be reduced by up to 50% given that the splitter is able to cut down on the wires coming into the street pole, and the splitter is able to split the main wire for each component installed on the light pole. This is advantageous in that it cuts down on the main wires needed from the system and allows each smart pole 100 to use less wires overall. Through the use of the splitter the installation time is able to be decreased greatly.

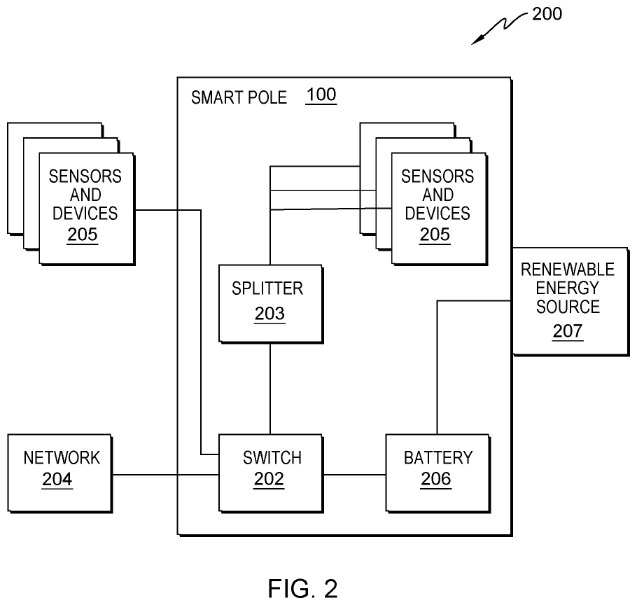

Depicted in FIG. 2 is a block diagram of the electrical system within the PoE smart pole 100, in accordance with one embodiment of the present invention. The switch 202 is the main connection point for all of the sensors and devices 205 attached to the smart pole 100. The switch 202 is able to receive a connection from each of the devices or sensors 205 and provides the means for power and control of these devices and sensors 205. Through the use of the PoE system, each device and sensors 205 needs one cable to provide both power and data transfer from said device or sensor 205. The switch 202 is then connected to the larger network 204 so data can be transferred from the smart pole 100 and the devices can be controlled remotely, or data can be transferred to a remote station related to each device or sensor 205. In the depicted embodiment a splitter 203 is used to further reduce the need for cables. The splitter 203 can be used to further expand upon the devices or sensors attached to the smart pole 100 if the switch 202 is full, or to reduce cables run from the switch 202 to the devices or sensors. The switch 202 for each smart pole 100 is connected to a network 204.

The network 204 may be a local area network (LAN), a wide area network (WAN) such as the Internet, any combination thereof, or any combination of connections and protocols that can support communications between the smart pole 100, the sensors and devices 205, and other smart poles 100 which are connected via the network 204 in accordance with embodiments of the invention. Network 102 may include wired, wireless, or fiber optic connections. Network 101 may also be a mesh network, where the nodes (e.g., components, devices, sensors, switches, etc.) are connected directly, dynamically, and non-hierarchically to as many other nodes as possible and cooperate with one another to efficiently route data to and from the nodes. The mesh network 101 is dynamic in that as nodes are added and removed, the connection between the nodes is modified or adjusted. The mesh network may be wireless, wired, or a hybrid of both.

All of the smart poles 100 are connected to a computing system 205 which controls the devices and sensors as well as receives data transferred from the devices and sensors to the computing system 205 or a computing device.

The smart pole 100 may have various forms of renewable energy sources 207 such as solar panels, turbines, or the like which are able to assist in providing additional power for the devices or sensors or to generate power which is supplied to a battery pack 206 contained within the base. The battery pack 206 is used to provide power to the devices and sensors in the event of a power failure in the system to allow for continued use of the devices and sensors. In some embodiments, a wireless means of communication is integrated into the system to allow for communication remotely if the wired connection fails.

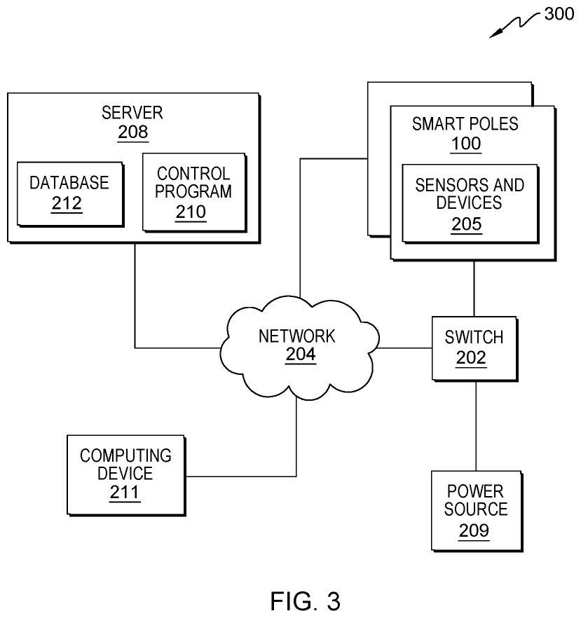

FIG. 3 depicts a block diagram of a PoE environment 300 in accordance with one embodiment of the present invention. FIG. 1 provides an illustration of one embodiment and does not imply any limitations regarding the environment in which different embodiments may be implemented. In the depicted embodiment, the PoE environment 300 includes network 204, server 208, computing devices 211, and smart poles 100. PoE environment 100 may include additional servers, computers, or other devices and PoE devices not shown.

The network 101 may be a local area network (LAN), a wide area network (WAN) such as the Internet, any combination thereof, or any combination of connections and protocols that can support communications between computing device 211, server 208, and the smart poles 100, in accordance with embodiments of the invention. Network 101 may include wired, wireless, or fiber optic connections. Network 101 may also be a mesh network, where the nodes (e.g., components, devices, sensors, switches, etc.) are connected directly, dynamically, and non-hierarchically to as many other nodes as possible and cooperate with one another to efficiently route data to and from the nodes. Network 101 is dynamic in that as nodes are added and removed, the connection between the nodes is modified or adjusted. The mesh network may be wireless, wired, or a hybrid of both.

A wired connection has a limitation of three hundred (300) approximate feet for both power and data to be transferred via the ethernet cable. This limitation thus seriously limits a purely wired system to a module or communication device every three hundred feet. The wireless system has a range of approximately two thousand (2,000) feet for the transfer of data, which provides an advantage over the wired system and allows the devices and modules to communicate with fewer control modules between them. With the mesh network design, the smart poles 100 can be connected over distances greater than two thousand feet) providing an even greater advantage of a typical Power over Ethernet network environment. A wired connection for power transfer does not have the same limitation as data transfer, and thus a wired connection for the power in the PoE system is used. In the depicted embodiment, the power source 209 may be any typical public or municipal power grid can be used and the connection from the power source to the smart poles 100, in this depicted embodiment, is via the PoE cabling. The power source 209 needs to be any source that is capable of providing adequate power to power the smart poles 100 and the sensors and driver 205. In additional embodiments, the power source 209 may be a renewable power source or the like. The switch 202 is in connection with the network 204 for data transfer and is connected to the power source 209 and the smart poles 100 for power transfer. The switch 202 can power multiple smart poles 100 from a central location.

Network 204 may be dynamic in the connection between the nodes to maintain an optimized connection as nodes are added or removed from the network 204. For example, if a smart pole 100 is removed or broken, the nodes are able to reroute the connection or convert a node into a router or gateway to allow a new connection path between the nodes so as to not loose connectivity between all the remaining nodes of the mesh network. In another embodiment, the mesh network 204 may have multiple sub networks which are identified within the larger mesh network 204. For example, a low energy network and a high-performance network may make up the mesh network 204 based on the desired power requirements and data transfer speeds of and between the nodes.

Thus, creating a PoE system unlike before where some smart poles 100 and the sensors and drivers 205 may be powered and communicate through a wired system where other smart poles 100 and the sensors and drivers 205 may be powered through an internal power supply and have a wireless communication. This is advantageous as it creates a system which provides for fewer cables and the ability to expand the system with ease.

Where a direct connection within the system 300 is present, it may be a category 6A U/UTP CMP/CMR cable or the like which is able to meet the power and signal requirements. This provides for the PoE connection to provide both power and control signals.

The server 208 may be a management server, a web server, or any other electronic device or computing system capable of processing program instructions and receiving and sending data. In other embodiments server 208 may be a laptop computer, tablet computer, netbook computer, personal computer (PC), a desktop computer, or any programmable electronic device capable of communicating via network 204. In one embodiment, server 208 may be a server computing system utilizing multiple computers as a server system, such as in a cloud computing environment. In one embodiment, server 208 represents a computing system utilizing clustered computers and components to act as a single pool of seamless resources. In the depicted embodiment database 212 and control program 210 are located on server 208. Server 208 may include components, as depicted, and described in further detail with respect to FIG. 3. In some embodiments, server 208 is a cloud service platform or a web service cloud-based service platform.

Control program 210 controls the operations of the smart poles 100 and the sensors and devices 205 based on data received and commands sent. In the depicted embodiment, Control program 210 utilizes network 204 to access the sensors and drivers 205 and communicates with switch 202 to perform various actions. In the depicted embodiment, Control program 210 resides on server 208. In other embodiments, Control program 210 may be located on another server or computing device, provided Control program 210 has access switch 202, sensors and driver 205, and database 212. The control program 210 is able to set features such as, but not limited to circadian rhythm, and timers.

Database 211 may be a repository that may be written to and/or read by control program 210. In one embodiment, database 211 is a database management system (DBMS) used to allow the definition, creation, querying, update, and administration of a database(s). In the depicted embodiment, database 211 resides on server 208. In other embodiments, database 211 resides on another server, or another computing device, provided that database 211 is accessible to Control program 210.

The computing device(s) 211 may be a management server, a web server, or any other electronic device or computing system capable of processing program instructions and receiving and sending data. In some embodiments, computing device 211 may be a laptop computer, tablet computer, netbook computer, personal computer (PC), a desktop computer, or any programmable electronic device capable of communicating with computing device 211 and server 208 via network 102. In other embodiments, computing device 211 may represent a server computing system utilizing multiple computers as a server system, such as in a cloud computing environment. In another embodiment, computing device 211 represents a computing system utilizing clustered computers and components to act as a single pool of seamless resources. In embodiments, computing device 211 may include any combination of Control program 210 or database 212. computing device 211 may include components. In the depicted embodiment the computing device 211 is connected to network 204 through a wireless 130 connection.

The Power over Ethernet (PoE) Switch 202 supplying power and data through a standard Ethernet cable is commonly called “Power-over-Ethernet,” or PoE technology which has an industry standard protocol called IEEE 802.3af/bt. An embodiment of the present invention supports the IEEE 802.3af/bt standard as well as a customized, novel PoE architecture which allows a user to select a multiple number of desired voltages and current levels for an output PoE port by instructing a microprocessor using an output voltage-adjusting interface. It is known that there are currently two standards for PoE systems: Institute of Electrical and Electronics Engineers (IEEE) 802.3af (the original PoE standard) provides up to 15.4 Watts of power, and IEEE 802.3bt (known as PoE plus) which provides up to 60 or 100 Watts. As new standards are developed or designed, this system is able to work with the new standards. Switch 202 has a built-in control module 119 for the transmitting, receiving, and process of data and requests and permits the switch 202 to perform the desired action based on the data. In some embodiments, the PoE switch 202 is an IEEE 802.3BT PoE switch and is only used for delivering power to the smart poles 100 but is not used for communication to the smart poles 100 in an effort to avoid any EMI communication disruption due to the higher-than-normal power.

Power source 209 is an uninterruptible power supply that provides constant and continuous power to the system with minimal disruptions in the power supply. Both in an emergency or on a regular basis the power source 209 may be used. Power source 209 may also have a built-in control module to allow communication with the other components. The control module transmits data with regards to grid power levels, battery life, battery charge levels and charge rate. This information is used to determine whether the battery is on grid or battery power to allow the system to determine if the emergency lighting scenario needs to be implemented. The battery along with the control module allows for an independent control of a lighting system. The power source 209 may also be various forms of renewable energy such as solar, wind, water, or the like forms of energy. In some embodiments, the power source 209 is an established power system or structure, for example, city or municipal provided power.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

In addition to being directed to the embodiments described above and claimed below, the present invention is further directed to embodiments having different combinations of the features described above and claimed below. As such, the invention is also directed to other embodiments having any other possible combination of the dependent features claimed below.

The present invention may be embodied in other specific forms without departing from the spirit or essential attributes thereof; and it is, therefore, desired that the present embodiment be considered in all respects as illustrative and not restrictive, reference being made to the appended claims rather than to the foregoing description to indicate the scope of the invention.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions,

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for the purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g., each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

What is claimed is:

1. A modularized private mesh networked streetlight pole, comprising:
a base;
a main body attached to the base;
a lamp mounted on the main body and having an electrical connection;
a first set of sensors affixed to an exterior of the main body and having electrical connections; and
a second set of sensors affixed to an interior of the main body having electrical connections.

2. The modularized private meshed networked streetlight pole of claim 1, further comprising, a switch electrically connected to the first set of sensors and the second set of sensors.

3. The modularized private meshed networked streetlight pole of claim 2, further comprising, a splitter connected to the switch and each of the second set of sensors.

4. The modularized private meshed networked streetlight pole of claim 2, further comprising, a splitter connected to the switch and each of the first set of sensors.

5. The modularized private meshed networked streetlight pole of claim 2, further comprising, an energy storage device connected to the switch.

6. The modularized private meshed networked streetlight pole of claim 5, further comprising, a renewable energy source connected to the energy storage device.

7. The modularized private meshed networked streetlight pole of claim 2, wherein the switch is wired to the network through a Power of Ethernet connection means.

8. The modularized private meshed networked streetlight pole of claim 2, wherein the switch is wirelessly connected to a network via a wireless networking component integrated into the switch.

9. A modularized private mesh networked streetlight pole, comprising:
a frame;
a switch integrated into the frame, wherein the switch is connected to a network;
a set of devices and sensors attached to the frame;

10. The modularized private meshed networked streetlight pole of claim 9, further comprising, a splitter electronically connected to the switch and to each of the set of devices and sensors.

11. The modularized private meshed networked streetlight pole of claim 9, wherein a first portion of the set of devices and sensors are attached to an exterior of the frame and a portion of the set of devices and sensors are within an interior of the frame.

12. The modularized private meshed networked streetlight pole of claim 9, further comprising a battery electronically connected to the switch.

13. The modularized private meshed networked streetlight pole of claim 9, further comprising, a point to multipoint communication module.

14. A modularized private mesh networked, comprising:
a group of smart poles connected to a network;
a switch connected to the network in communication with the group of smart poles; and
a power source connected to the switch, wherein the switch controls the power to the group of smart poles.

15. The modularized private mesh networked of claim 14, further comprising sensors and devices integrated into each of the group of smart poles and in electronic communication with a control program via the network.

16. The modularized private mesh networked of claim 14, wherein the group of smart poles are nodes within the network.

17. The modularized private mesh networked of claim 14, wherein the group of smart poles are connected through a wired connection, and wherein the wired connection transfers power and data.

18. The modularized private mesh networked of claim 14, wherein the group of smart poles are connected through a wired and a wireless connection, and wherein the wired connection transfers power and the wireless connection transfers data.

19. The modularized private mesh networked of claim 14, wherein a control program receives data from the group of smart poles and processes commands to the switch.
